(19) United States
(12) Patent Application Publication
(10) Pub. No.: US 2016/0131194 A1
(43) Pub. Date: May 12, 2016

(54) SWIVEL JOINT DISASSEMBLY TOOL AND METHOD FOR SAME

(71) Applicant: FORUM US, INC., Houston, TX (US)

(72) Inventor: Andrew J. JOHNSON, Corpus Christi, TX (US)

(21) Appl. No.: 14/876,401

(22) Filed: Oct. 6, 2015

Related U.S. Application Data
(60) Provisional application No. 62/076,921, filed on Nov. 7, 2014.

(51) Int. Cl. F16C 43/06; B25B 27/14

(52) U.S. Cl. CPC F16C 43/06; B25B 27/14

(57) ABSTRACT

A swivel joint disassembly tool includes a compliant body having a first side and a second side, and a plurality of ball ejection tabs disposed adjacent to an opening formed in the compliant body, the plurality of ball ejection tabs extending from the second side and being positioned along an axis that forms an acute angle relative to a longitudinal axis of the compliant body.

### CROSS-REFERENCE TO RELATED APPLICATION

This application claims benefit of United States Provisional Patent Application Ser. No. 62/076,921, filed on Nov. 7, 2014, which application is herein incorporated by reference in its entirety.

### BACKGROUND

1. Field

Embodiments of the present disclosure generally relate to methods and apparatus for disassembly of swivel joints utilized in hosing and piping systems.

2. Description of the Related Art

Swivel joints are used in hosing and piping systems in a wide range of industries including the petroleum industry, the chemical industry, the petrochemical industry, as well as mining, refining, distilling, brewing and paint industries, among others. Swivel joints are typically two metallic piping components having balls disposed at an interface between the two piping components, which allows 360 degree rotation of one of the piping components relative to the other while maintaining a fluid-tight seal.

Periodically, a swivel joint must be disassembled for repair or maintenance of the hosing or piping system. Disassembly of swivel joints requires removal of the balls between the two piping components. A conventional method for removing the balls from a swivel joint is time consuming and has safety concerns. Conventionally, on large swivel joint assemblies, two technicians are needed to dissamble the swivel joint. One technician inserts a flat blade screw driver into holes formed in one of the the piping components that provide access to the balls. The other technician must rotate the mating piping component. The flat blade screw driver is used as a “stop” during the rotation of the mating pipng component. When the balls contact the screw driver, the balls are ejected out of the hole based on the rotation of the mating piping component. The process is similar on smaller swivel joint assemblies except that one technician can rotate the mating piping component while simultaneously holding the screw driver.

Safety is an issue in both of the disassembly procedures due to the use of the flat blade screw driver since the technician could lose control of either or both of the screw driver and the mating piping component, which could cause injuries to the technician and/or to personnel in the vicinity. Further, in many swivel joint assemblies, there are multiple raceways containing balls that need to be removed through separate holes in the piping component. Thus, the screw driver insertion procedure is repeated numerous times, which increases disassembly time and the possibility of injury.

Therefore, there is a need for an improved swivel joint disassembly tool and disassembly method.

### SUMMARY

Embodiments of the present disclosure generally relate to methods and apparatus for disassembly of swivel joints utilized in hosing and piping systems. In one embodiment, a swivel joint disassembly tool is provided. The swivel joint disassembly tool includes a compliant body having a first side and a second side, and a plurality of ball ejection tabs disposed adjacent to an opening formed in the compliant body, the plurality of ball ejection tabs extending from the second side and being positioned along an axis that forms an acute angle relative to a longitudinal axis of the compliant body.

In another embodiment, a swivel joint disassembly tool is provided. The swivel joint disassembly tool includes a compliant body having a first side and a second side, an attachment member coupled to opposing ends of the first side, and plurality of ball ejection tabs disposed adjacent to openings formed in the compliant body, wherein each of the ball ejection tabs comprises a lip and a notch.

In another embodiment, a method for disassembling a swivel joint assembly having a first piping component coupled with a second piping component is provided. The method includes placing a swivel joint disassembly tool proximate to an interface between the first piping component and the second piping component of the swivel joint assembly, the swivel joint disassembly tool having a plurality of ball ejection tabs, each ball ejection tab disposed adjacent to an opening formed therein, inserting each of the ball ejection tabs into a ball access hole formed in the interface, securing the swivel joint disassembly tool about the interface, and rotating one of the first piping component or the second piping component relative to the other to eject a plurality of balls from the interface through at least one of the openings.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is an isometric top view of a swivel joint disassembly tool according to one embodiment.

FIG. 2 is an isometric bottom view of the swivel joint disassembly tool of FIG. 1.

FIG. 3 is a side view of the swivel joint disassembly tool of FIG. 1.

FIG. 4 is a schematic top view of one embodiment of a swivel joint assembly having the swivel joint disassembly tool disposed thereon.

FIG. 5 is a cross-sectional view of the swivel joint assembly along a longitudinal axis of the swivel joint disassembly tool of FIG. 4.

FIG. 6 is a cross-sectional view of a portion of the swivel joint assembly of FIG. 4 along a longitudinal axis of the swivel joint assembly.

FIG. 7 is an isometric top view of a swivel joint disassembly tool according to another embodiment.

FIG. 8 is an isometric top view of a swivel joint disassembly tool according to another embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the disclosure provide methods and apparatus for disassembly of swivel joints utilized in hosing and piping systems.

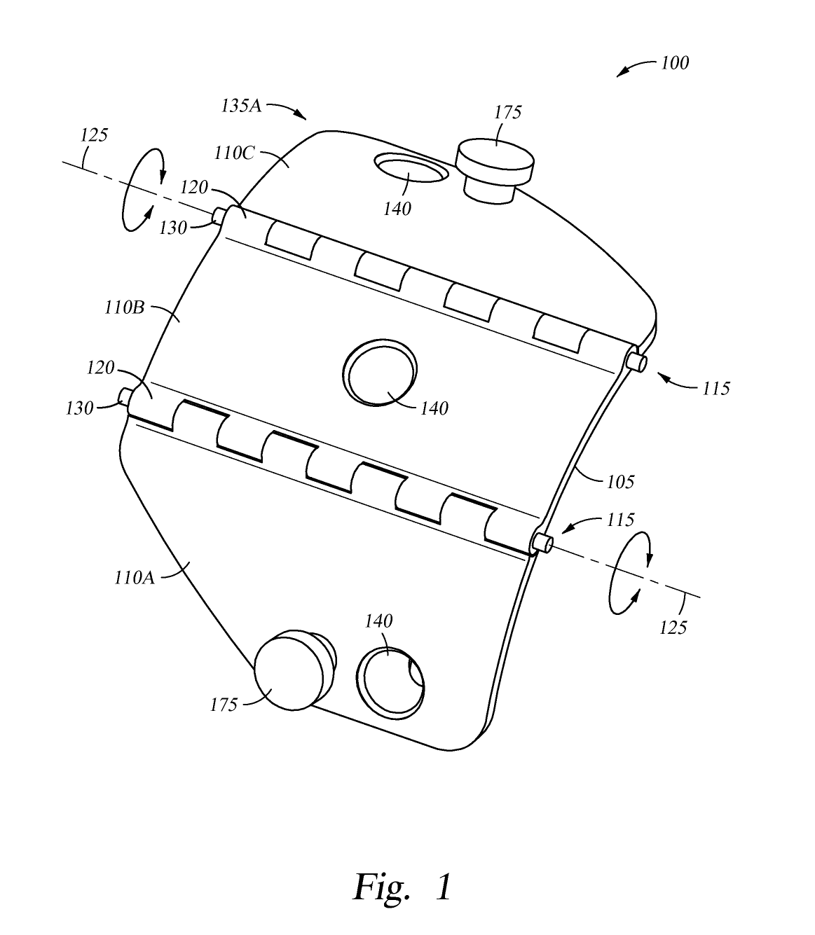

FIG. 1 is an isometric top view of the swivel joint disassembly tool 100. The swivel joint disassembly tool 100 comprises a body 105 made of a polymer material. In one embodiment, the body 105 is compliant and is made of a flexible material to facilitate installation and/or removal of the swivel joint disassembly tool 100 during use. Examples of the material for the body 105 include thermoplastic materials, such as acrylonitrile butadiene styrene (ABS), nylon, polypropylene, polyether polystyrene, polyethylene, polycarbonate, among others. The body 105 may be one-piece or include two or more segments (three are shown in FIG. 1) that are coupled to each other by a flexible joint 115.

In the embodiment shown in FIG. 1, three segments 110A-110C are coupled together at the flexible joints 115, and the flexible joints 115 comprise a hinge 120. In other embodiments, the flexible joints 115 may comprise a groove, a depression, or a region of material having a thinner cross-section than the remainder of the body 105. Each hinge 120 may include a pin 130 having an axis of rotation 125 such that the segments 110A-110C may move relative to each other about the axis of rotation 125. The body 105 and/or any of the three segments 110A-110C of the swivel joint disassembly tool 100 as described herein may be produced in a three-dimensional printing process, injection molded, or machined.

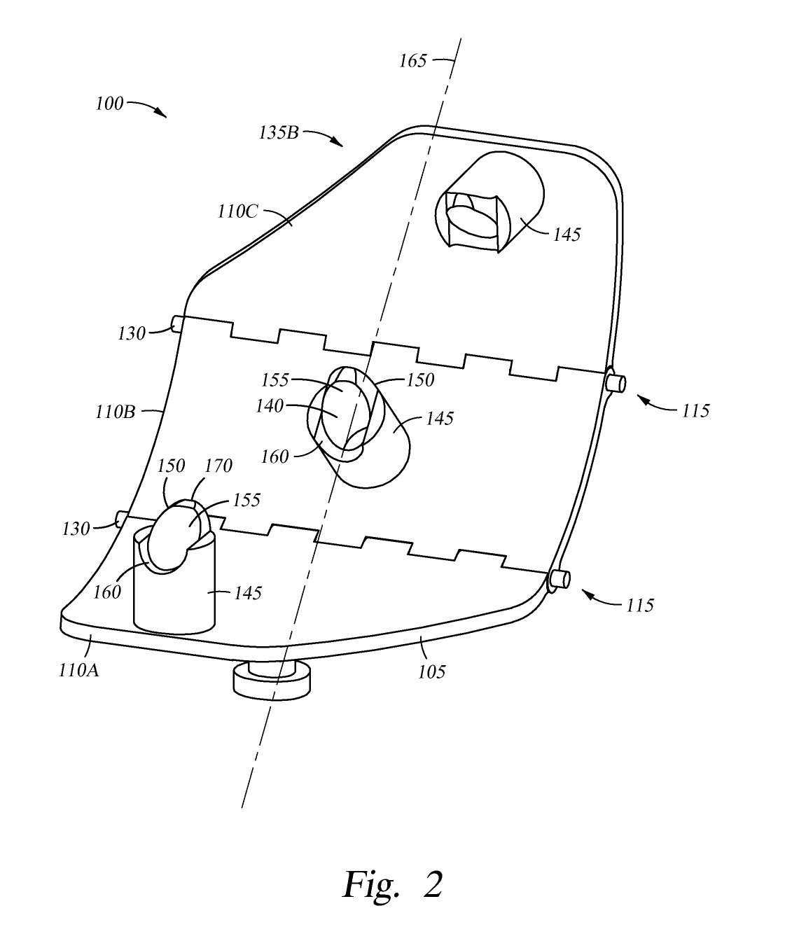

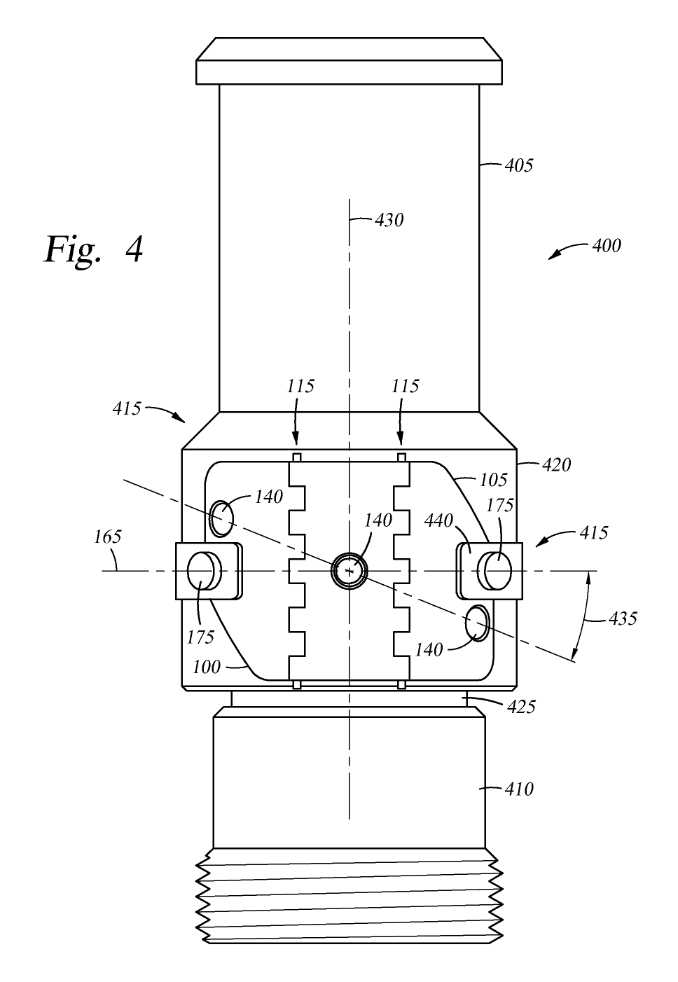

FIG. 2 is an isometric bottom view of the swivel joint disassembly tool 100. As shown in FIGS. 1 and 2, the swivel joint disassembly tool 100 includes a first side 135A and a second side 135B. The second side 135B may be utilized to at least partially surround and contact at least a portion of an outer surface of a piping component of a swivel joint (as shown in FIGS. 4-6). The body 105 is flexible in one embodiment, such that the body 105 may bend to substantially conform to the outer surface of the swivel joint. While two flexible joints 115 are shown, the swivel joint disassembly tool 100 may include more than two depending on factors, such as the size of the swivel joint to be disassembled, the flexibility of the body 105, among other factors. For example, swivel joints having outside diameters greater than about six to about eight inches may require more than two flexible joints in order to fit snugly about the outer diameter of the swivel joint to be disassembled.

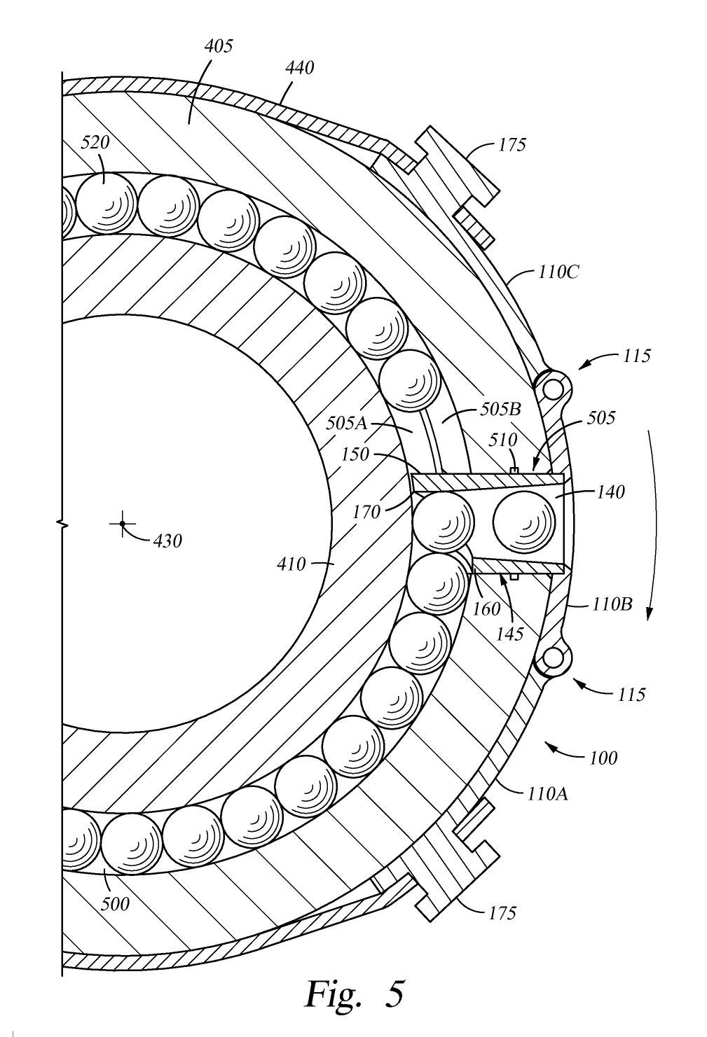

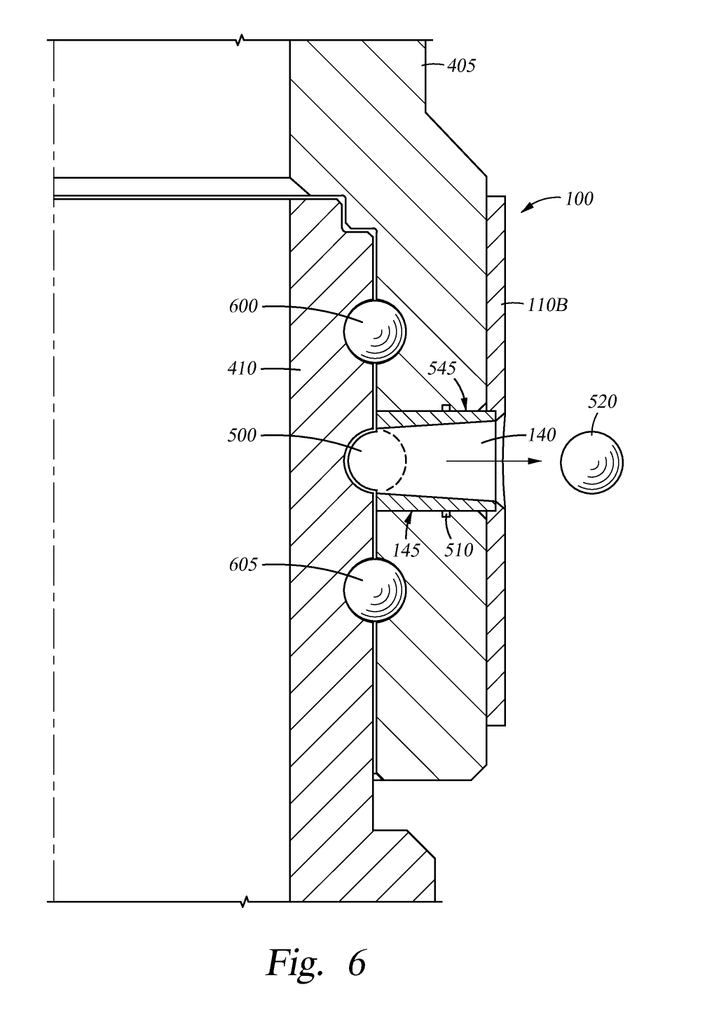

The first side 135A of the swivel joint disassembly tool 100 includes openings 140 formed in each of the segments 110A-110C. An inside dimension of the openings 140 are sized to provide passage of a ball (as shown in FIGS. 5 and 6) from the swivel joint during a disassembly procedure. In one example, the openings 140 are sized to provide passage of a ball having a diameter of about 0.375 inches. The openings 140 extend through the body 105 to the second side 135B and are disposed adjacent to (e.g. coupled to or integral with) a ball ejection tab 145 that protrudes from the second side 135B. Various other sizes of balls, such as balls with a diameter of 0.625 inches and 0.75 inches, may be used in other swivel joints, and the openings 140 are sized to accommodate the diameters of any sizes of balls.

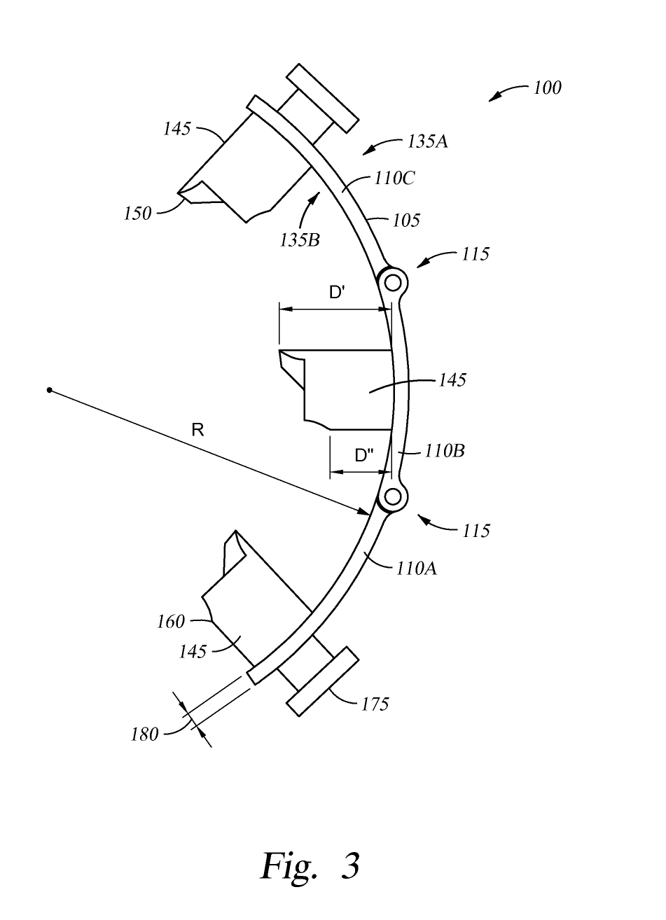

FIG. 3 is a side view of the swivel joint disassembly tool 100. As shown in FIG. 3, each ball ejection tab 145 includes a lip 150 that extends a first distance D′ away from the second side 135B. The first distance D′ is dimensioned according to a dimension of the piping component of the swivel joint to be disassembled, such as the wall thickness of the piping component, such that the lip 150 extends past the wall thickness of the piping component and at least partially into a raceway formed in the mating piping component that holds the balls (as shown in FIGS. 5 and 6). Each of the ball ejection tabs 145 also includes a notch 160 that extends a second distance D″ from the second side 135B. The second distance D″ is less than the first distance D′. The difference between the first distance D′ and the second distance D″ is substantially equal to, or slightly larger than, the diameter of a ball in the swivel joint to be disassembled. In the embodiment shown in FIGS. 1-3, the lip 150 and the notch 160 of each of the ball ejection tabs 145 are oriented in the same direction relative to the longitudinal axis 165 the body 105. In use, as will be explained in greater detail below, a ball enters the notch 160 along the longitudinal axis 165 and contacts a surface 155 of the lip 150. The surface 155 acts as a stop, which causes the ball to travel through the opening 140 and eject out of the opening 140 in the first side 135A. The lip 150 and the notch 160 may be oval or semicircular in shape. In some embodiments, the lip 150 includes a flat 170 to ensure the ball ejection tab 145 does not extend too far into the swivel joint to be disassembled.

Referring to FIGS. 1 and 3, the swivel joint disassembly tool 100 also includes attachment members or handles 175 disposed on opposing sides of the body 105. In the embodiment shown, the handles 175 are disposed on the first side 135A on each of the segments 110A and 110C. The handles 175 may be utilized as handles and/or as an attachment point for a strap or flexible member. In one embodiment, a slot, that may used to secure the swivel joint disassembly tool 100 in place during use, may be formed in one or both of the segments 110A and 110C.

Referring to FIG. 3, each of the segments 110A-110C of the body 105 include a thickness 180 that, in one embodiment, is the same for each segment. In some embodiments, the thickness 180 is chosen, at least in part, to provide flexibility of each of the segments 110A-110C at room temperature, which allows the swivel joint disassembly tool 100 to flexibly conform to a radius R, which may be the outside radius of a piping component of a swivel joint to be disassembled. In other embodiments, one or all of the segments 110A-110C may be formed to include the radius R such that the body 105 is semi-rigid and the segments 110A-110C are curved. In one specific example, the thickness 180 may be about 0.125 inches to about 0.20 inches and the radius R may be about 2.7 inches (for a 3 inch swivel joint having an outside diameter of 5⅜ inches). In one embodiment, the body 105 is compliant or flexible at room temperature and includes a modulus of elasticity of about 1.0 gigapascals (GPa) to about 3.1 GPa.

FIGS. 4-6 are various views of a swivel joint assembly 400 showing the operation of the swivel joint disassembly tool 100 of FIGS. 1-3. FIG. 4 is a schematic top view of one embodiment of the swivel joint assembly 400 having the swivel joint disassembly tool 100 disposed thereon. FIG. 5 is a cross-sectional view of the swivel joint assembly 400 along the longitudinal axis 165 of the swivel joint disassembly tool 100. FIG. 6 is a cross-sectional view of a portion of the swivel joint assembly 400 of FIG. 4 along a longitudinal axis 430 of the swivel joint assembly 400. The exemplary swivel joint assembly 400 is shown as a thread to wing swivel joint, but may be a flange to flange swivel joint assembly, a thread to thread swivel joint assembly, a weld to weld swivel joint assembly, or any combination of a weld with a wing, a flange, or a thread.

Referring to FIGS. 4 and 5, the swivel joint assembly 400 includes a first piping component 405 and a second piping component 410 coupled together at an interface 415. Although shown as straight pipe segments, one or both of the first piping component 405 and the second piping component 410 may comprise a curved or bent pipe segment, such as an elbow. The interface 415 includes a body 420 of the first piping component 405 and a tail 425 of the second piping component 410. One or more seals, as well as one or more ball raceways (one is shown in FIG. 5 as ball raceway 500) each having a plurality of balls 520, are located within the interface 415. The ball raceway 500 may include a first portion 505A formed in the second piping component 410 and a second portion 505B formed in the first piping component 405. When coupled together at the interface 415, one or both of the first piping component 405 and the second piping component 410 can rotate a full 360 degrees relative to the other while maintaining a fluid-tight seal therebetween. The balls 520, rotating in each raceway, reduce friction between the first piping component 405 and the second piping component 410.

The swivel joint disassembly tool 100 is positioned on the body 420 such that the longitudinal axis 165 is substantially normal to the longitudinal axis 430 of the swivel joint assembly 400. The openings 140 of the swivel joint disassembly tool 100 are aligned with ball access holes (one is shown in FIG. 5 as ball access hole 505) that are formed in the body 420. The middle opening 140 as shown in FIG. 4 is in communication with the ball raceway 500 through the ball access hole 505 shown in FIGS. 5 and 6. The uppermost or leftmost opening 140 as shown in FIG. 4 is in communication with a ball raceway 600 shown in FIG. 6 via a ball access hole that is not shown. Likewise, the lowermost or rightmost opening 140 as shown in FIG. 4 is in communication with a ball raceway 605 shown in FIG. 6 via a ball access hole that is not shown. In some embodiments, the middle ball ejection tab 145 may be inserted into the ball access hole 505 prior to the insertion of other ball ejection tabs 145. An operator may then lift the handles 175 to insert the other ball ejection tabs 145 into the respective ball access holes. Lifting the handles 175 may cause the flexible joints 115 to move such that the outer segments 110A and 110C move relative to the middle segment 110B in order to facilitate alignment of the other ball ejection tabs 145 with the respective ball access holes. Additionally, depending on the flexibility of the body 105, lifting of a handle 175 may cause the outer segments 110A or 110C to bend slightly, which may further facilitate alignment of the other ball ejection tabs 145 with the respective ball access holes.

When the swivel joint assembly 400 is operational, the ball access holes (505 and others) would be plugged and a retaining ring (not shown) would be positioned in a groove 510 (shown in FIG. 5 in the ball access hole 505) to retain the balls 520 in each ball raceway 500, 600, and 605. However, as shown in FIG. 5, the retaining ring and ball plug is removed so the ball ejection tabs 145 may be inserted into the ball access hole 505 (as well as other ball access holes (not shown)).

In some swivel joint assemblies, the ball access holes are staggered along the length of the interface 415 as shown and, accordingly, the openings 140 (and corresponding ball ejection tabs 145) are inclined and positioned along an axis having an angle 435 relative to the longitudinal axis 430 of the swivel joint assembly 400. In some embodiments, the angle 435 is an acute angle (i.e., less than 90 degrees, such as about 45 degrees). However, in other swivel joint assemblies, the ball access holes may be positioned along the longitudinal axis 430 of the swivel joint assembly 400. In this embodiment, the openings 140 (and corresponding ball ejection tabs 145) would be positioned along the longitudinal axis 430 of the swivel joint assembly 400.

As shown in FIGS. 4 and 5, a retaining member 440 is coupled to the body 105 which secures the swivel joint disassembly tool 100 about the outer diameter of the body 420 of the swivel joint assembly 400. The retaining member 440 may be a strap, such as a hook and loop material, a bungee cord, or other type of tie-down strap. The retaining member 440 may be coupled to the handles 175 as shown, or be otherwise coupled with opposing ends of the body 105. One or a combination of the thickness 180 of the body 105, the flexibility of the material of the body 105, and the flexible joints 115, allows the body 105 to be in proximity to the outer surface of the body 420 of the swivel joint assembly 400. The retaining member 440 fixes the body 105 in the position where the ball ejection tabs 145 align with the ball access holes on the swivel joint assembly 400.

As shown in FIGS. 5 and 6, relative rotation of the first piping component 405 with the second piping component 410 causes the balls 520 to roll into contact with the lip 150 of the ball ejection tab 145 that extends into the corresponding raceway 500, 600, 605 and be ejected from the ball access holes 505 through the corresponding opening 140. In the embodiment shown in FIG. 5, the first piping component 405 is rotated clockwise while the second piping component 410 is stationary. In other embodiments, the second piping component 410 may be rotated counterclockwise while the first piping component 405 is stationary. While only the center ball access hole 505 is shown ejecting a ball 520 in FIGS. 5 and 6, the other ball ejection tabs 145 would operate similarly. Additionally, the other ball ejection tabs 145 may eject the balls 520 from the respective ball raceways 600 and 605 at the same time that the balls 520 are ejected from the ball raceway 500. Thus, all of the balls 520 are removed from the ball raceways 500. 600 and 605 at or near the same time using the swivel joint disassembly tool 100.

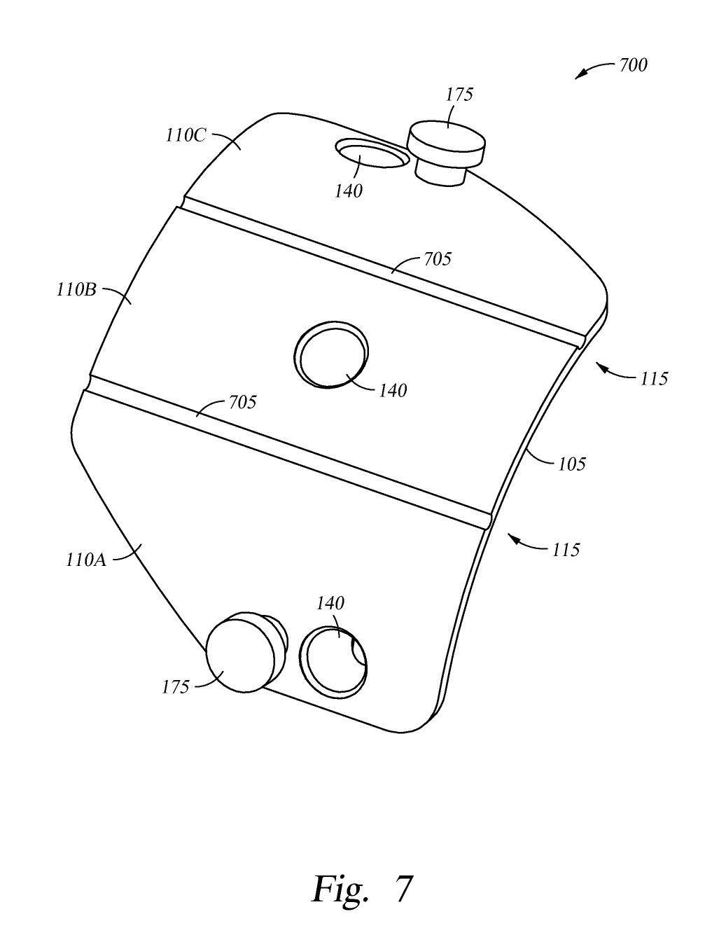

FIG. 7 is an isometric top view of a swivel joint disassembly tool 700 according to another embodiment. The swivel joint disassembly tool 700 is substantially the same as the swivel joint disassembly tool 100 described in FIGS. 1-6, except that the flexible joint 115 in this embodiment comprises a linear groove 705. The linear groove 705 may be a region of material having a thinner cross-section than the remainder of the body 105 of the swivel joint disassembly tool 700.

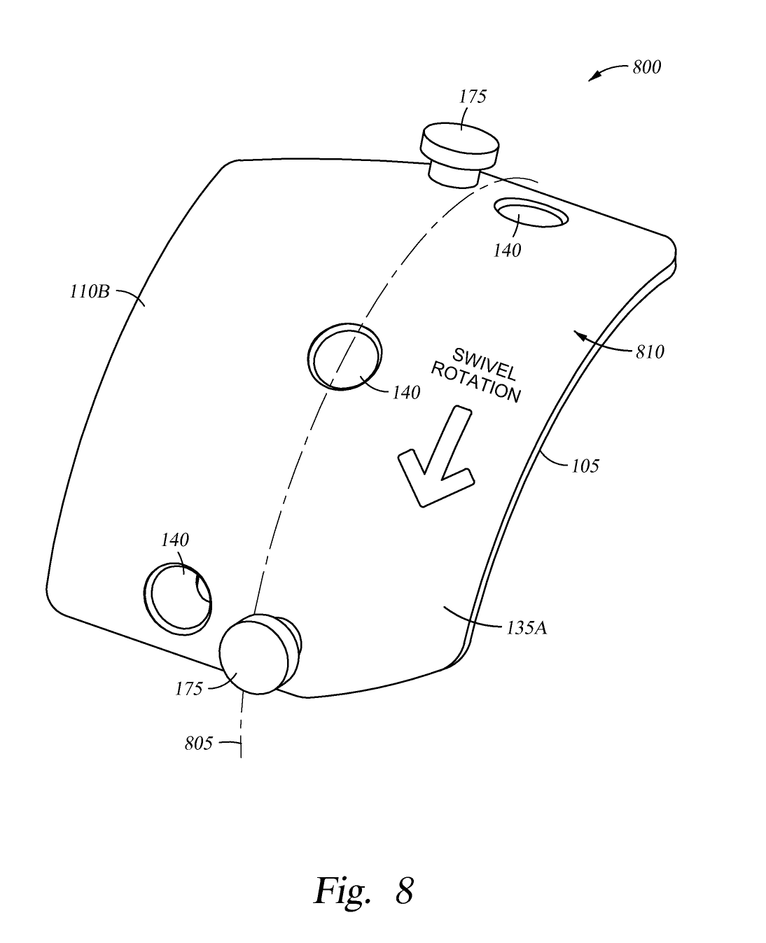

FIG. 8 is an isometric top view of a swivel joint disassembly tool 800 according to another embodiment. The swivel joint disassembly tool 800 is substantially the same as the swivel joint disassembly tools 100, 700 described in FIGS. 1-7 with the following exceptions. The body 105 of the swivel joint disassembly tool 800 according to this embodiment is singular or one piece such that no hinges or grooves are needed. In this example, the body 105 may be pre-stressed or biased such that the body 105 is curved or curls in toward itself along a longitudinal axis 805 of the body 105. As such, when the swivel joint disassembly tool 800 is utilized, the body 105 may flexibly conform to a radius R (shown in FIG. 3), which may be the outside radius of a piping component of a swivel joint to be disassembled. In addition, a legend 810, which indicates the direction in which to rotate the swivel joint assembly when using the swivel joint disassembly tool 800, is included on the first side 135A of the body 105.

The swivel joint disassembly tools 100, 700, and 800 as described herein provides safe dissassembly of the swivel joint assembly 400 by a single technician. All of the balls 520 in all of the ball raceways 500, 600, and 605 are removed at the same time as opposed to removing the balls from one ball raceway at a time. No other tools, such as a screw driver, are necessary, which increases safety. The technician is free to use two hands to rotate the swivel joint assembly 400, which provides for a more controlled disassembly procedure. Additionally, disassembly time is reduced since all of the balls 520 are removed with one revolution of the first piping component 405 relative to the second piping component 410, or vice versa. Utilization of the retaining member 440 may be used to fix the swivel joint disassembly tool 100 in place thus allowing the technician to rotate the first piping component 405 or the second piping component 410 relative to the other.

While the foregoing is directed to embodiments of the present disclosure, other and further embodiments of the disclosure may be devised without departing from the basic scope thereof, and the scope thereof is determined by the claims that follow.

1. A swivel joint disassembly tool, comprising:
a compliant body having a first side and a second side; and
a plurality of ball ejection tabs, each ball ejection tap disposed adjacent to an opening formed in the compliant body, wherein the plurality of ball ejection tabs extend from the second side and are positioned along an axis that forms an acute angle relative to a longitudinal axis of the compliant body.

2. The tool of claim 1, wherein each of the ball ejection tabs comprises a lip and a notch.

3. The tool of claim 2, wherein the lip and the notch are oriented in the same direction relative to the longitudinal axis of the compliant body.

4. The tool of claim 2, wherein the lip extends a first distance from the second side and the notch extends a second distance from the second side, the first distance being greater than the second distance.

5. The tool of claim 4, wherein a difference between the first distance and the second distance is equal to, or slightly greater than, a diameter of a ball in a swivel joint assembly.

6. The tool of claim 1, wherein the compliant body is one-piece.

7. The tool of claim 1, wherein the compliant body comprises a flexible joint.

8. The tool of claim 7, wherein the flexible joint comprises a hinge.

9. A swivel joint disassembly tool, comprising:
a compliant body having a first side and a second side;
a handle extending from the first side on opposing ends of the compliant body; and
a plurality of ball ejection tabs disposed adjacent to openings formed in the compliant body, wherein each of the ball ejection tabs comprises a lip and a notch.

10. The tool of claim 9, wherein the lip and the notch are oriented in the same direction relative to a longitudinal axis of the compliant body.

11. The tool of claim 9, wherein the lip extends a first distance from the second side and the notch extends a second distance from the second side, the first distance being greater than the second distance.

12. The tool of claim 11, wherein a difference between the first distance and the second distance is equal to, or slightly greater than, a diameter of a ball in a swivel joint assembly.

13. The tool of claim 9, wherein the compliant body comprises a flexible joint.

14. The tool of claim 13, wherein the flexible joint comprises a hinge.

15. The tool of claim 9, wherein the compliant body is one-piece.

16. A method for disassembling a swivel joint assembly having a first piping component coupled with a second piping component, the method comprising:
placing a swivel joint disassembly tool proximate to an interface between the first piping component and the second piping component of the swivel joint assembly, the swivel joint disassembly tool having a plurality of ball ejection tabs, each ball ejection tab disposed adjacent to an opening formed therein;
inserting each of the ball ejection tabs into a ball access hole formed in the interface;
securing the swivel joint disassembly tool about the interface; and
rotating one of the first piping component or the second piping component relative to the other to eject a plurality of balls from the interface through at least one of the openings.

17. The method of claim 16, wherein each of the ball ejection tabs comprises a lip and a notch, each of the lip and the notch being oriented in the same direction relative to a longitudinal axis of the swivel joint disassembly tool.

18. The method of claim 17, wherein the lip extends a first distance from the second side and the notch extends a second distance from the second side, the first distance being greater than the second distance.

19. The method of claim 18, wherein a difference between the first distance and the second distance is equal to, or slightly greater than, a diameter of each of the plurality of balls in the swivel joint assembly.

20. The method of claim 16, wherein the plurality of ball ejection tabs are aligned along an axis that forms an acute angle relative to a longitudinal axis of the swivel joint assembly.
